(19) United States
(12) Patent Application Publication
(10) Pub. No.: US 2023/0057703 A1
(43) Pub. Date: Feb. 23, 2023

(54) METHOD AND APPARATUS FOR CREATING INTERACTIVE VIDEO, DEVICE, AND COMPUTER-READABLE STORAGE MEDIUM

(71) Applicant: Tencent Technology (Shenzhen) Company Limited, Shenzhen (CN)

(72) Inventors: Lu LYU, Shenzhen (CN); Wei HONG, Shenzhen (CN)

(73) Assignee: Tencent Technology (Shenzhen) Company Limited, Shenzhen (CN)

(21) Appl. No.: 17/981,127

(22) Filed: Nov. 4, 2022

Related U.S. Application Data
(63) Continuation of application No. PCT/CN2021/119639, filed on Sep. 22, 2021.

(30) Foreign Application Priority Data
Oct. 16, 2020 (CN) 202011110802.X

(51) Int. Cl. H04N 21/472

(52) U.S. Cl. CPC H04N 21/47205

(57) ABSTRACT

A method for creating an interactive video is provided. In the method, an interactive video creation interface is displayed. The interactive video creation interface includes a video editing preview region and a component editing region. A first interactive clip is added to the video editing preview region. The first interactive clip includes a display scene. An information viewing component is added to a target position in the display scene of the first interactive clip based on selection of an information viewing option that is included in the component editing region. The information viewing component is configured to present information in the display scene when selected by a user of the interactive video. The interactive video is generated according to the information viewing component added to the first interactive clip.

### RELATED APPLICATIONS

The present application is a continuation of International Application No. PCT/CN2021/119639, entitled “INTERACTIVE VIDEO CREATION METHOD AND APPARATUS, DEVICE, AND READABLE STORAGE MEDIUM” and filed on Sep. 22, 2021, which claims priority to Chinese Patent Application No. 202011110802.X, entitled “METHOD AND APPARATUS FOR CREATING INTERACTIVE VIDEO, DEVICE, AND COMPUTER-READABLE STORAGE MEDIUM” and filed on Oct. 16, 2020. The entire disclosures of the prior applications are hereby incorporated by reference in their entirety.

### FIELD OF THE TECHNOLOGY

Embodiments of this application relate to the field of multimedia, including to a method and an apparatus for creating an interactive video, a device, and a computer-readable storage medium.

### BACKGROUND OF THE DISCLOSURE

The interactive video is a video form in which an interaction component is set and provided for users to interact with the plot. For example, if the content being played in an interactive video is that a role A is communicating with a role B, and the role A says to the role B that “Shall we have fried chicken or hot pot this evening”, two options, that is, fried chicken and hot pot, are displayed during playback of the interactive video, and video clips of different subsequent plot developments are played according to users' choices of the options.

Usually, during setting of interaction components, for the development of a plot, interaction components are set according to cohesion relationships between different video clips, so that a plurality of video clips are connected to form an interactive video with a complete plot. Users make selections on interaction components corresponding to different plots, so as to choose development directions of the plot of the interactive video.

However, during the setting of the interaction components, a selection can only be made for the development direction of the plot.

### SUMMARY

Embodiments of this disclosure provide a method and an apparatus for creating an interactive video, a device, and a non-transitory computer-readable storage medium. Technical solutions include the following:

According to an aspect, a method for creating an interactive video is provided. In the method, an interactive video creation interface is displayed. The interactive video creation interface includes a video editing preview region and a component editing region. A first interactive clip is added to the video editing preview region. The first interactive clip includes a display scene. An information viewing component is added to a target position in the display scene of the first interactive clip based on selection of an information viewing option that is included in the component editing region. The information viewing component is configured to present information in the display scene when selected by a user of the interactive video. The interactive video is generated according to the information viewing component added to the first interactive clip.

According to another aspect, an apparatus including processing circuitry is provided. The processing circuitry is configured to display an interactive video creation interface. The interactive video creation interface includes a video editing preview region and a component editing region. The processing circuitry is configured to add a first interactive clip to the video editing preview region, the first interactive clip including a display scene. The processing circuitry is configured to add an information viewing component to a target position in the display scene of the first interactive clip based on selection of an information viewing option that is included in the component editing region, the information viewing component being configured to present information in the display scene when selected by a user of the interactive video. Further, the processing circuitry is configured to generate an interactive video according to the information viewing component added to the first interactive clip.

According to another aspect, a computer device is provided, including a processor and a memory, the memory storing at least one instruction, at least one program, a code set, or an instruction set, and the at least one instruction, the at least one program, the code set, or the instruction set being loaded and executed by the processor to implement the method for creating an interactive video according to one of the foregoing aspects and any one of the exemplary embodiments thereof.

According to another aspect, a non-transitory computer-readable storage medium is provided, storing instruction which executed by a processor cause the processor to implement the method for creating an interactive video according to one of the foregoing aspects and any one of the exemplary embodiments thereof.

According to another aspect, a computer program is provided, including computer instructions, the computer instructions being stored in a computer-readable storage medium. A processor of a computer device reads the computer instructions from the computer-readable storage medium and executes the computer instructions to cause the computer device to perform the method for creating an interactive video according to one of the foregoing aspects and any one of the exemplary embodiments thereof.

Technical solutions provided in the embodiments of this disclosure include at least the following beneficial effects:

In a process of creating an interactive video, a first interactive clip is set in the interactive video, an information viewing component is set in the first interactive clip, and acquirable information in an information acquisition scene provided in the first interactive clip is presented by using the information viewing component, so as to increase an amount of information and interaction forms of the interactive clip in the interactive video. A user can view information included in the first interactive clip by selecting the information viewing component in the first interactive clip, thereby improving the efficiency of acquiring information by the user in an interaction process of the interactive video.

### BRIEF DESCRIPTION OF THE DRAWINGS

FIG. 1 is a schematic diagram of an interaction method of an interactive video according to an exemplary embodiment of this disclosure.

FIG. 2 is a schematic diagram of an interaction method of an interactive video according to an exemplary embodiment of this disclosure.

FIG. 3 is a schematic diagram of an implementation environment of a method for creating an interactive video according to an exemplary embodiment of this disclosure.

FIG. 4 is a flowchart of a method for creating an interactive video according to an exemplary embodiment of this disclosure.

FIG. 5 is a schematic diagram of setting an information viewing component in a creation interface based on the embodiment shown in FIG. 4.

FIG. 6 is a flowchart of a method for creating an interactive video according to another exemplary embodiment of this disclosure.

FIG. 7 is a schematic interface diagram of setting a voting component in a creation interface based on the embodiment shown in FIG. 6.

FIG. 8 is a flowchart of a method for creating an interactive video according to another exemplary embodiment of this disclosure.

FIG. 9 is a schematic diagram of setting a character selection component in a creation interface based on the embodiment shown in FIG. 8.

FIG. 10 is a schematic diagram of a setting interface of a plot selection control based on the embodiment shown in FIG. 8.

FIG. 11 is a schematic diagram of a setting interface of a global control based on the embodiment shown in FIG. 8.

FIG. 12 is a structural block diagram of an interactive video playback system according to an exemplary embodiment of this disclosure.

FIG. 13 is a structural block diagram of an interactive video playback system according to another exemplary embodiment of this disclosure.

FIG. 14 is a schematic diagram of a data exchange according to an exemplary embodiment of this disclosure.

FIG. 15 is a structural block diagram of an apparatus for creating an interactive video according to an exemplary embodiment of this disclosure.

FIG. 16 is a structural block diagram of an apparatus for creating an interactive video according to another exemplary embodiment of this disclosure.

FIG. 17 is a structural block diagram of a terminal according to an exemplary embodiment of this disclosure.

### DESCRIPTION OF EMBODIMENTS

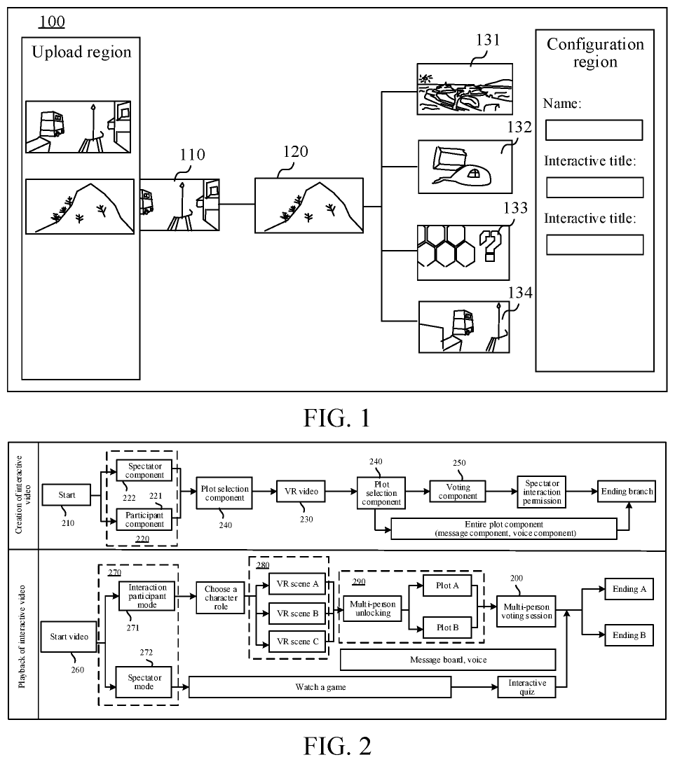

FIG. 1 shows a schematic diagram of an exemplary interface for creating an interactive video. In a creation interface 100 for an interactive video, cohesion relationships of the interactive video are displayed. After being completely played, a video clip 110 is followed by a video clip 120. Further, the video clip 120 is followed by four video clips, including a video clip 131, a video clip 132, a video clip 133, and a video clip 134. That is, after the video clip 120 is played, plot options are displayed in the interface. The plot options may be displayed during playback of the video clip 120, or may be displayed after the playback of the video clip 120 is completed, and the video playback process is suspended. For example, a plot option A corresponds to the video clip 131, a plot option B corresponds to the video clip 132, a plot option C corresponds to the video clip 133, and a plot option D corresponds to the video clip 134.

The interactive video provided in this embodiment of this disclosure, based on the foregoing plot selection, further provides: interaction forms such as multi-participant interaction, video content interaction, voting interaction, and information communication interaction.

With reference to the foregoing interaction forms, the overall interaction procedure of the interactive video provided in this embodiment of this disclosure is schematically described. First, a user watches a background video clip in the interactive video. The background video clip is used for telling a story background corresponding to the interactive video. After playback of the background video clip is completed, the computer device displays an interaction form selection control in a playback interface of the interactive video. The interaction form selection control includes a participant control and a spectator control. When the participant control is selected, it indicates that the user participates in the interaction process of the interactive video in the form of a player, and one interactive video corresponds to at least two players. When the spectator control is selected, it indicates that the user watches the interaction process of the interactive video.

In an example, after the participant control is selected, a player role A, a player role B, and a player role C are displayed. A player may choose a to-be-played role from the three roles, or the system automatically assigns a corresponding role to each player.

After the role selection is completed, plot video clips corresponding to different roles are played for each player to understand the plot corresponding to the role of the each player. According to the plot video clip played for each player, the players may discuss with each other and perform communication such as sharing information and inquiring about doubts.

The interactive video further provides at least two virtual reality (VR) scenes. The VR scenes correspond to the player roles or are related to the plot. The player may make a selection from at least two VR scenes, so that the selected VR scene is displayed, perform information query in this VR scene, and discuss with other players for analysis according to the queried information. A plurality of players may also select a plot direction, and the plot direction selected by a majority of players may be used as a plot direction of the interactive video.

The interactive video further provides a voting control. Voting is performed for player roles, a player role that best meets the voting requirements is selected from the plurality of player roles, and an ending video is played according to a voting result.

The order of stages in the foregoing interaction process is merely an example. In an actual interaction process, the order of stages can be freely matched with the design of the creator, which is not limited in this embodiment of this disclosure.

In an exemplary embodiment, as shown in FIG. 2, which is a schematic diagram of an interaction method of an interactive video according to an exemplary embodiment of this disclosure, a creation structure for an interactive video includes a video architecture of the interactive video, including: a starting stage 210 for playing a story background video of the interactive video; and an interaction form selection component 220, including a participant component 221 and a spectator component 222, where the participant component 221 is used for enabling a player to participate in the interaction process of the interactive video, and the spectator component 222 is used for enabling the user to watch the interaction process of the interactive video; an identity selection component is further correspondingly set in the participant component 221, the identity selection component including different options set for different identities in the interactive video, so that the player can choose, from the options, an identity role that the player wants to play; and different identity roles also correspond to different plot videos for the user to learn of the plot of a story corresponding to the identity role to be played by the user.

The interactive video further includes a VR video 230. An interaction component is set in the VR video 230. The interaction component is used for implementing an information viewing function in the VR video 230. For example, if the VR video is implemented as a scene of a living room, an interaction component is set at a corner of the sofa in the living room. When the interaction component is clicked, a letter and the content of the letter left at the corner of the sofa is displayed.

The interactive video further includes a plot selection component 240. After a candidate plot is selected in the plot selection component 240, a plot direction of the interactive video is controlled. In an example, when there are a plurality of players participating in the interaction, according to selections made by the players from a plurality of plots, the plot is developed to a candidate plot that is most selected.

The interactive video further includes a voting component 250, used for selecting an identity role that meets a voting requirement from identity roles played by the plurality of players. According to the situation that the identity roles are selected, different result videos are played correspondingly.

Corresponding to the creation structure of the interactive video, in a playback structure of the interactive video, a start video 260 is played first. The start video 260 is used for expressing a story background of the interactive video. Upon completion of playback of the start video 260 or during playback of the start video 260, an interaction form selection component 270 is displayed, including a participant component corresponding to an interaction participant mode 271 and a spectator component corresponding to a spectator mode 272. The interaction participant mode 271 is used for indicating that the player participates in the interaction process of the interactive video, for example, viewing scene information in an interaction scene of the interactive video. The spectator mode 272 is used for indicating that the user watches the interaction process of the interactive video, and during a spectator process, the spectator can view a perspective video of a role in the storyline, but cannot participate in voting or selection. Alternatively, the spectator can choose to view a storyline direction according to the storyline of the user, and watch content such as a player's speech, and finally, participate in voting or selection. In the interaction participant mode 271, the player can also choose an identity, and choose, from different options corresponding to different identities in the interactive video, an identity role that the player wants to play. In addition, different identity roles also correspond to different plot videos, after completing the selection of the identity role, through the plot videos, the player can learn of the plot of the story corresponding to the identity role that the player plays.

The interactive video further includes a VR scene 280. An interaction component is set in the VR scene 280. The interaction component is used for implementing an information viewing function in the VR scene 280.

The interactive video further includes a plot selection process 290. After a candidate plot is selected in the plot selection process 290, a plot direction of the interactive video is controlled.

The interactive video further includes a multi-person voting session 200, used for selecting an identity role that meets a voting requirement from identity roles played by the plurality of players. According to the situation that the identity roles are selected, different result videos are played correspondingly.

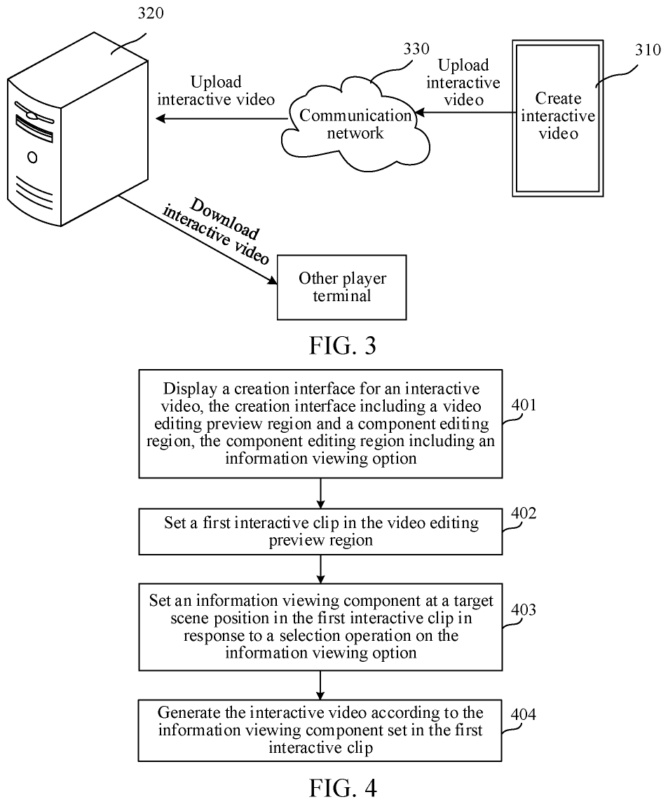

FIG. 3 is a schematic diagram of an implementation environment of a method for creating an interactive video according to an exemplary embodiment of this disclosure. The implementation environment includes: a terminal 310 and a server 320.

A multimedia application is installed in the terminal 310, for example, a video playback application or a video processing application. The multimedia application provides an interactive video creating function. Through the interactive video creating function, the user creates an interactive video in the multimedia application, and adds an interactive video clip and a component in the newly created interactive video.

After the terminal 310 connects the interactive video clip and the component together according to a plot association relationship, to finally generate an interactive video, the terminal 310 uploads the interactive video to the server 320 through a communication network 330, so that a player terminal can obtain the interactive video from the server 320 and interact with other player terminals in the interactive video.

The player terminal creates a room for the interactive video, and invites other player terminals to participate in the interaction of the interactive video.

In an example, the foregoing server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart television, a smartwatch, or the like, but is not limited thereto. The terminal may be connected to the server directly or indirectly in a wired or wireless communication manner, which is not limited in this embodiment of this disclosure.

With reference to the foregoing description of the implementation environment, the method for creating an interactive video provided in this embodiment of this disclosure is described. This method may be performed by the terminal or the server or may be performed by the terminal and the server together. That is, the computer device may include at least one of the terminal or the server.

FIG. 4 is a flowchart of a method for creating an interactive video according to an exemplary embodiment of this disclosure. Descriptions are provided by using an example in which the method is performed by the terminal. The method may include the following steps.

In step 401, a creation interface is displayed for an interactive video, the creation interface including a video editing preview region and a component editing region, the component editing region including an information viewing option.

In an example, the creation interface is used for creating an interactive video. The creation interface is used for determining an overall structure of the interactive video, and/or used for setting a video clip and an interaction component in the interactive video.

The video editing preview region is used for setting and previewing the video clip in the interactive video. The component editing region is used for setting the interaction component based on the video clip that has been set.

In some embodiments, the video editing preview region is further used for previewing the overall structure of the interactive video, for example, cohesion relationships between video clips, and/or association relationships between the video clips and components that have been set.

The foregoing component editing region includes a component editing option. The component editing option includes an information viewing option. The information viewing option is used for instructing to add an information viewing component in the video, so that when a selection operation on the information viewing component is received, information included in the information viewing component is presented. The information viewing component is used for being set in a VR scene. Alternatively, the information viewing component is used for being set at specified position in the video clip.

The video editing preview region and the component editing region are two regions displayed side by side in the creation interface. Schematically, the video editing preview region is located on the left side of the creation interface, and the component editing region is located on the right side of the creation interface.

In some embodiments, a video clip is first set in the video editing preview region, so that an interaction component is set for the video clip. For example, an information viewing component is set at any position of the video clip, or a selection component is set at an ending position of the video clip, and so on.

In some embodiments, when no video clip is set in the video editing preview region, or no corresponding video clip is specified for setting of an interaction component, the interaction component is set at the start position, at the ending position, or within a specified time period of the interactive video.

In step 402, a first interactive clip is set in the video editing preview region. In an example, a first interactive clip is added to the video editing preview region, the first interactive clip including a display scene.

The first interactive clip is used for providing an information acquisition scene. A manner of setting the first interactive clip includes at least one of the following:

First, the first interactive clip has been locally stored in the terminal. After the terminal opens the multimedia application and displays the creation interface, the user drags the first interactive clip to the creation interface, so as to set the first interactive clip in the creation interface.

When the first interactive clip is dragged, the first interactive clip is directly dragged to an expected playback position of the first interactive clip in the interactive video. Alternatively, the first interactive clip is dragged into the video editing preview region of the interactive video, and a playback position of the first interactive clip is set in a setting parameter of the first interactive clip. In an example, the first played video clip is set to No. 1, the second played video clip is set to No. 2, and if in the third stage, there are three side-by-side video clips, the three side-by-side video clips are respectively set to No. 3-1, No. 3-2, and No. 3-3, represent the juxtaposition relationship of the three video clips.

Second, the first interactive clip has been locally stored in the terminal. After the terminal opens the multimedia application and displays the creation interface, the user selects a video clip upload control in the video editing preview region, and correspondingly, selects the first interactive clip that has been locally stored. After the first interactive clip is uploaded, a playback position of the first interactive clip is set.

Third, n video clips are first uploaded in the creation interface, n being a positive integer, and the n video clips including the first interactive clip. The video clips are set sequentially according to the playback order, which includes the setting of the first interactive clip.

Fourth, an overall frame of the interactive video is first created in the creation interface, and the first interactive clip is uploaded for the overall frame at a playback position corresponding to the first interactive clip.

The foregoing manners of setting the first interactive clip are merely examples, and a specific manner of setting the first interactive clip is not limited in the embodiments of this disclosure.

In an example, the first interactive clip is an ordinary video clip. Alternatively, the first interactive clip is a VR video clip, that is, the first interactive clip provides a VR scene, and the player can interact with an object in the scene in the VR scene. Similarly, an information viewing component may also be set in the VR scene for indicating information included in the object in the VR scene.

In an example, the first interactive clip is a virtual reality clip, and correspondingly, the information acquisition scene is a three-dimensional virtual scene presented in the virtual reality clip. The first interactive clip may also be implemented as a VR three-dimensional virtual scene, and a corresponding viewing time limit is set in the VR three-dimensional virtual scene. The player may search the VR three-dimensional virtual scene for information within a duration range of the viewing time limit.

In an example, in a setting process of the VR three-dimensional virtual scene, a three-dimensional virtual scene model that has been locally stored in the terminal is imported into the media application, and a display position of the VR three-dimensional virtual scene is set.

In step 403, an information viewing component is set at a target scene position in the first interactive clip in response to a selection operation on the information viewing option. In an example, an information viewing component is added to a target position in the display scene of the first interactive clip based on selection of an information viewing option that is included in the component editing region, the information viewing component being configured to present information in the display scene when selected by a user of the interactive video.

The information viewing component is used for presenting acquirable information in the information acquisition scene. For example, the acquirable information includes scene information and component information. That is, the scene information corresponding to a target scene position is set correspondingly for the information viewing component. For example, the scene information “View the note in the door slit” is set correspondingly for the information viewing component, and the information viewing component corresponds to the note at a position of the door slit. The information viewing component also corresponds to specific component information. For example, for the scene information “View the note in the door slit” content of the note is also correspondingly set. The target display scene is at least one scene included in the information acquisition scene. In an example, the first interactive clip includes a plurality of information acquisition scenes. Each information acquisition scene corresponds to at least one display scene. For example, the information acquisition scene may be an exhibition hall, and a rest area of the exhibition hall is a display scene, and a commodity exhibition area of the exhibition hall is another display scene.

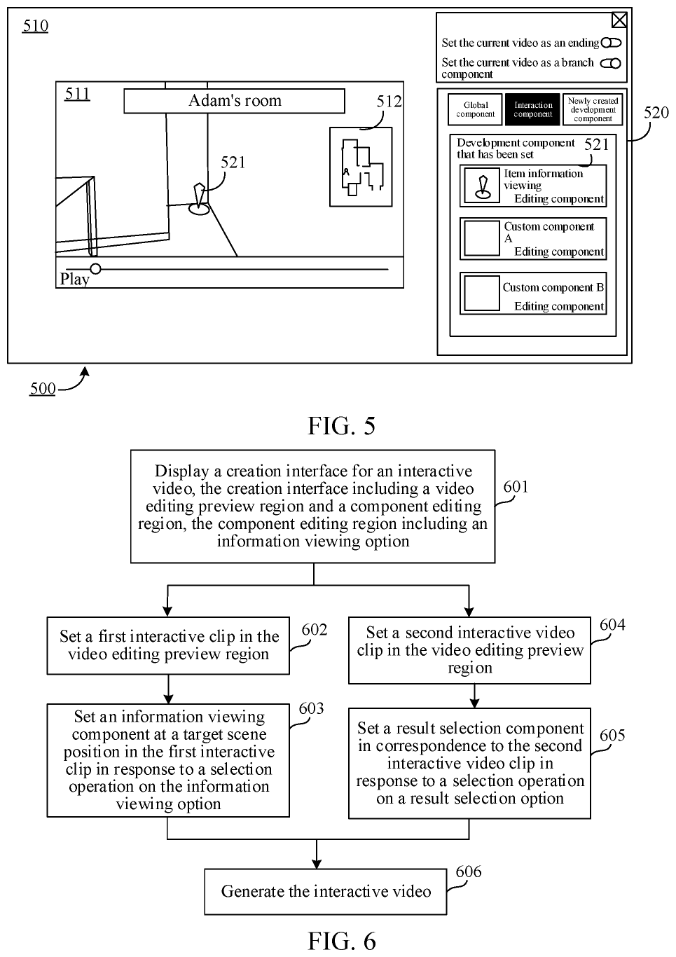

In an example, in a case that the first interactive clip is a virtual reality clip, and the information acquisition scene is a three-dimensional virtual scene presented in the virtual reality clip, the target scene position is a three-dimensional position in the three-dimensional virtual scene. For example, as shown in FIG. 5, an information viewing component 521 is located in a VR three-dimensional virtual scene 511, and a target scene position of the information viewing component 521 is a three-dimensional position.

In an example, when the information viewing component is set for the first interactive clip, any of the following cases is included:

First, if the first interactive clip is implemented as a first interactive video clip, during playback of the first interactive video clip, the information viewing component is set for a key frame, so that during the playback of the first interactive video clip, when a key frame (I frame) in which the information viewing component is set and video frames (P frame and B frame) corresponding to the key frame are played, the information viewing component is correspondingly shown.

Second, if the first interactive clip is implemented as a virtual reality clip, that is, the first interactive clip is a VR three-dimensional virtual scene that includes a time limit, the information viewing component is set at a target position in the VR three-dimensional virtual scene. In a case that the player views the VR three-dimensional virtual scene, when the target position is viewed, the information viewing component is displayed. In an example, the user drags the information viewing component to adjust the position of the information viewing component in the VR three-dimensional virtual scene.

In some embodiments, the information viewing component is set at a preset position in the target display scene of the first interactive clip, and a drag operation on the information viewing component is received. The drag operation is used for moving a set position of the information viewing component in the target display scene. The target scene position of the information viewing component in the target display scene is determined according to the drag operation, and the information viewing component is set at the target scene position.

In an example, before the set position of the information viewing component is determined, or after the set position of the information viewing component is determined, information content included in the information viewing component is set. The content included in the information viewing component includes at least one of scene information or component information. The scene information is used for indicating a title of the information content included in the indication information viewing component, and the component information is used for indicating the information content included in the information viewing component. With reference to the foregoing example, “View the note in the door slit” is the scene information, that is, the title of the information content. Content of the note in the door slit, that is, “Meeting in the conference room at 6:00 pm”, is component information, that is, the information content. In an example, the information viewing component also corresponds to an information editing control. For example, the component editing region further includes a component editing control corresponding to the information viewing component. An information editing region is displayed in response to a trigger operation on the component editing control, the information editing region including an information title editing region and an information content editing region. A title input operation in the information title editing region is received, and a title corresponding to the information viewing component is generated. A content input operation in the information content editing region is received, and information content corresponding to the information viewing component is generated. For example, the information editing region can be a part or all of the component editing region. In addition, the editing order of the title and content of the information is not defined in this embodiment.

Referring to FIG. 5, a creation interface 500 includes a video editing preview region 510 and a component editing region 520. A VR three-dimensional virtual scene 511 that has been set in the interactive video is displayed in the video editing preview region 510. A name “Adam's Room” is set for the VR three-dimensional virtual scene 511, and a three-dimensional scene top view 512 is also correspondingly displayed. Components that can be set in the VR three-dimensional virtual scene 511 are displayed in the component editing region 520, and include an information viewing component 521. When the information viewing component 521 is set in the VR three-dimensional virtual scene 511, the information viewing component 521 is dragged into the VR three-dimensional virtual scene 511, and is dragged to a corresponding target position. In an example, one or more information viewing components 521 may be set in the VR three-dimensional virtual scene 511. An upper limit is correspondingly set for a set quantity of information viewing components 521, or an unlimited quantity of information viewing components 521 may be set.

In step 404, the interactive video is generated according to the information viewing component set in the first interactive clip. In an example, the interactive video is generated according to the information viewing component added to the first interactive clip.

With reference to other interactive video clips, an interactive video for video interaction is finally generated according to the first interactive clip and the information viewing component set in the first interactive clip.

In conclusion, in the method for creating an interactive video provided in this embodiment, in a process of creating an interactive video, a first interactive clip is set in the interactive video, an information viewing component is set in the first interactive clip, scene information corresponding to a scene in which the first interactive clip is located is set in the information viewing component, so as to increase an amount of information and interaction forms of the interactive clip in the interactive video. A user can view information included in the first interactive clip by selecting the information viewing component in the first interactive clip, thereby improving the efficiency of human computer interaction in an interaction process of the interactive video.

In an embodiment, the component editing option further includes a result selection option. That is, the player can select a result according to information viewed in the first interactive clip, and view different interactive video endings according to the selected results. FIG. 6 is a flowchart of a method for creating an interactive video according to another exemplary embodiment of this disclosure. Descriptions are provided by using an example in which the method is performed by the terminal. The method may include the following steps:

In step 601, a creation interface for an interactive video is displayed, the creation interface including a video editing preview region and a component editing region, the component editing region including an information viewing option. In an example, an interactive video creation interface is displayed, the interactive video creation interface including the video editing preview region and the component editing region.

The component editing region further includes a result selection option. The result selection option is used for providing the player with selectable development results of the storyline of the interactive video. For example, the component editing region includes a component editing option. The component editing option further includes a result selection option.

In step 602, a first interactive clip is set in the video editing preview region.

In step 603, an information viewing component is set at a target scene position in the first interactive clip in response to a selection operation on the information viewing option.

In step 604, a second interactive video clip is set in the video editing preview region.

The second interactive video clip is used for providing result presentation content. In an example, a second interactive video clip is set in the video editing preview region. The second interactive video clip is used for guiding plot development.

In an example, a manner of setting the second interactive video clip includes at least one of the following:

First, the second interactive video clip is locally stored in the terminal. After the terminal opens the multimedia application and displays the creation interface, the user drags the second interactive video clip to the creation interface, so as to set the second interactive video clip in the creation interface.

When the second interactive video clip is dragged, the second interactive video clip is directly dragged to an expected playback position of the second interactive video clip in the interactive video. Alternatively, the second interactive video clip is dragged into the video editing preview region of the interactive video, and a playback position of the second interactive video clip is set in a setting parameter of the second interactive video clip.

Second, the second interactive video clip is locally stored in the terminal. After the terminal opens the multimedia application and displays the creation interface, the user selects a video clip upload control in the video editing preview region, and correspondingly, selects the second interactive video clip has been locally stored. After the second interactive video clip is completely uploaded, a playback position of the second interactive video clip is set.

Third, n video clips are first uploaded in the creation interface, n being a positive integer, and the n video clips including the second interactive video clip. The video clips are set sequentially according to the playback order, which includes the setting of the second interactive video clip.

Fourth, an overall frame of the interactive video is first created in the creation interface, and the second interactive video clip is uploaded for the overall frame at a playback position corresponding to the second interactive video clip.

The foregoing manners of setting the second interactive video clip are merely examples, and a specific manner of setting the second interactive video clip is not limited in the embodiments of this disclosure.

In an example, the second interactive video clip is used for guiding presentation of a result selection component. The second interactive video clip and the first interactive clip may be implemented as the same clip or different clips.

In step 605, a result selection component is set in correspondence to the second interactive video clip in response to a selection operation on the result selection option.

The result selection component is used for selecting an ending of the interactive video. The result selection component includes at least two candidates. Each candidate corresponds to one plot development result. Alternatively, i candidates correspond to k plot development results, where i and k are both positive integers, and i≥k.

In this embodiment, descriptions are provided by using an example in which the second interactive video clip may be set first, and then, the result selection component is set. In actual operations, the result selection component may be set first, and then, the second interactive video clip is set. In this embodiment of this disclosure, the setting order of the result selection component and the second interactive video clip is not limited.

In an example, the result selection component is set at the end of the second interactive video clip, or the result selection component is set at a transition position between the second interactive video clip and the result video.

In some embodiments, the result selection component includes at least two candidates, the at least two candidates including a target candidate. A result video setting operation on the target candidate is received, so that a target result video is set, according to the result video setting operation, as a result video associated with the target candidate.

In some embodiments, for different quantities of players participating in the interactive video, manners of setting the result video are also different, including at least one of the following cases:

First, the interactive video is a video in which a single player participates in interaction. That is, in an interaction process of the interactive video, the player views information in the first interactive clip, continues to view the second interactive video clip in the interactive video, and then makes a selection from at least two candidates. For the selection made by the player, a corresponding result video is played. Therefore, in a process of setting candidates and result videos, only correspondences between the candidates and the result videos need to be determined, so that a corresponding result video is played when a selection operation is performed on one of the candidates is received.

Second, the interactive video is a video in which a plurality of players participate in interaction. That is, in an interaction process of the interactive video, the plurality of players view information in the first interactive clip, continue to view the second interactive video clip, and then respectively make selections from at least two candidates. For the selections made by the plurality of players, a result video corresponding to the most selected candidate is played. Therefore, in a process of setting candidates and result videos, it is necessary to set scores corresponding to quantities of times that the candidates are selected, so that a candidate with the highest score is determined from scores corresponding to at least two candidates respectively, and a result video corresponding to the candidate is played.

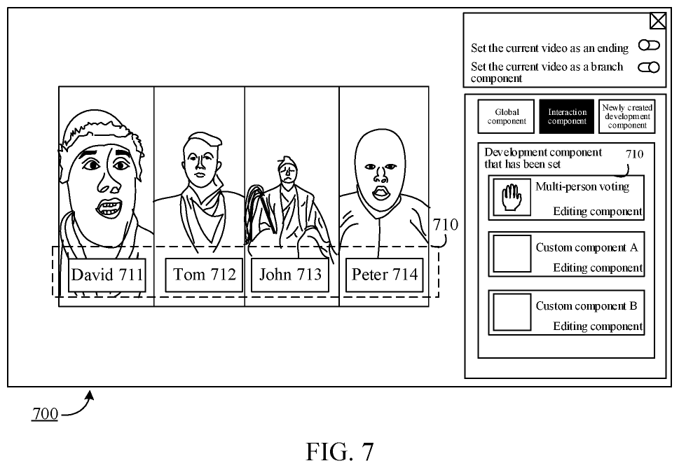

Referring to FIG. 7, a creation interface 700 for an interactive video includes a voting component 710, including four options: a control 711 (corresponding to David), a control 712 (corresponding to Tom), a control 713 (corresponding to John), and a control 714 (corresponding to Peter). When the voting component 710 is set, any one of the following manners is included. First, the voting component 710 is dragged to any position of the interface, and a name of the voting component 710 is correspondingly set. For example, the control 711 is dragged to any position, and a name corresponding to the control 711 is correspondingly set as David. Second, a selection operation on a setting control of the voting component is received, a setting option is displayed according to the selection operation, where the setting option includes a quantity of voting components, names corresponding to the voting component, and the like, and a voting interface in the interactive video is generated according to setting content in a setting option, and a preset arrangement manner of the voting component.

In step 606, the interactive video is generated.

With reference to other interactive video clips, an interactive video for video interaction is finally generated according to the first interactive clip and the information viewing component set in the first interactive clip.

In conclusion, in the method for creating an interactive video provided in this embodiment, in a process of creating an interactive video, a first interactive clip is set in the interactive video, an information viewing component is set in the first interactive clip, scene information corresponding to a scene in which the first interactive clip is located is set in the information viewing component, so as to increase an amount of information and interaction forms of the interactive clip in the interactive video. A user can view information included in the first interactive clip by selecting the information viewing component in the first interactive clip, thereby improving the efficiency of human computer interaction in an interaction process of the interactive video.

In the method provided in this embodiment, a result selection component is further set in a process of creating the interactive video, so that the user can predict a result of the interactive video, and view a result video clip according to the predicted result, which increases the amount of information and the interactive forms of the interactive clip in the interactive video.

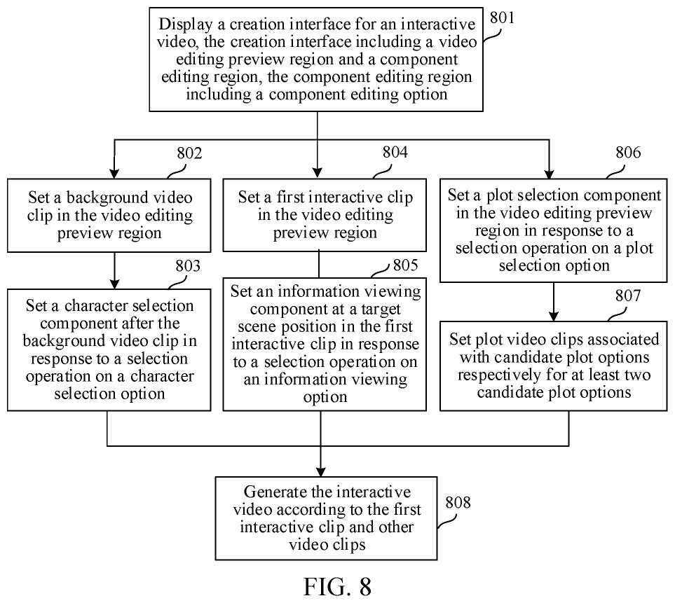

In an embodiment, in the interactive video, a plurality of players participate in interaction, FIG. 8 is a flowchart of a method for creating an interactive video according to another exemplary embodiment of this disclosure. Descriptions are provided by using an example in which the method is performed by the terminal. The method may include the following steps:

In step 801, a creation interface for an interactive video is displayed, the creation interface including a video editing preview region and a component editing region, the component editing region including a component editing option.

The component editing region is used for setting the interaction component based on the video clip that has been set. The component editing region includes a component editing option. The component editing option includes at least one of an information viewing option, a result selection option, a character selection option, and a plot selection option.

The information viewing option is used for setting an information viewing component in the interactive clip in the interactive video. The result selection option is used for providing a result selection component for predicting or selecting an ending of the interactive video. The character selection option is used for providing the user with a character control component for selecting a played role in the interactive video. The plot selection option is used for providing a plot selection component for selecting a storyline direction of the interactive video.

The information viewing component is used for being set in a VR scene. Alternatively, the information viewing component is used for being set at specified position in the video clip. In this embodiment, descriptions are provided by using an example in which the information viewing component is set in a VR scene.

The result selection component is used for being set in a preamble video clip before the result video clip. Alternatively, the result selection component is used for being set in a result selection interface before the result video clip.

The character selection component is used for being set in a background video clip to provide the user with controls for selecting a character. Alternatively, the character selection component is used for being set in a character selection interface after a background video clip. Alternatively, the character selection component is used for being set in a character selection interface before the background video clip.

The plot selection component is used for being set in any video clip in the interactive video, and is used for providing selections of subsequent plot directions. Alternatively, the plot selection component is used for being set in a plot selection interface in the interactive video, and is used for providing selections of subsequent plot directions.

In step 802, a background video clip is set in the video editing preview region.

The background video clip is used for providing a story background of the interactive video. In an example, the background video clip is a start video clip of the interactive video. That is, the first clip when playback of the interactive video is started is the background video clip.

In an example, when the background video clip is set, the background video clip is directly dragged into the video editing preview region. Alternatively, in an interactive video structure displayed in the video editing preview region, a position corresponding to the background video clip is selected, and the background video clip is set at the position.

Descriptions are provided by using an example in which the background video clip is set for the interactive video. When no background video clip is set in the interactive video, that is, when the interactive video starts, the character selection interface is directly displayed.

In step 803, a character selection component is set after the background video clip in response to a selection operation on a character selection option.

The character selection component is used for selecting a played role in the interactive video. The character selection component includes at least two character selection options. In an example, each character selection option in the at least two character selection options corresponds to one character selection component. Alternatively, one character selection component is set. The character selection component includes at least two character selection options.

When the character selection component is set after the background video clip, any one of the following cases is included:

First, the character selection component is displayed at the end of the background video clip in a superimposed manner. In an example, when display logic of the character selection component is set, the character selection component is set to be displayed continuously until the user selects a specific character selection component. If the user does not make a selection on the character selection component after playback of the background video clip is completed, displaying of a specified image frame is kept until the user selects a specific character selection component. Alternatively, an unselected character role is randomly assigned to the user.

Second, the background video clip is followed by a character selection interface, where a character selection component is set in the character selection interface. The character selection interface may be set during creation of the interactive video, or may be selected according to the background video clip. For example, any image frame is selected from the background video clip as the character selection interface. Alternatively, the first frame of the background video clip is used as the character selection interface. Alternatively, the last frame of the background video clip is used as the character selection interface.

In an example, before the character selection component is set in the interactive video, a matching component and a room creation component are further set. The matching component is used for instructing the player to be randomly matched with other players participating in the interactive video, and make a character selection. The room creation component is used for instructing the player to create a room and invite other players to interact with the interactive video.

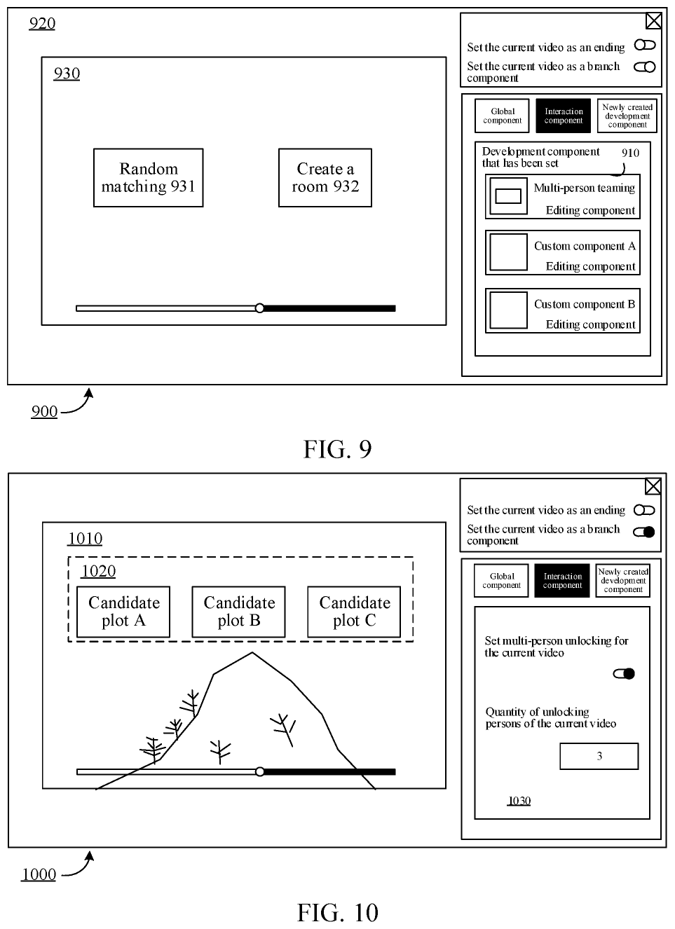

FIG. 9 is a schematic diagram of setting a character selection component in a creation interface according to an exemplary embodiment of this disclosure. A character selection option 910 is displayed in a creation interface 900 for an interactive video, and an interface 930 currently set in the interactive video is displayed in a video editing preview region 920. A matching control 931 and a room creation control 932 are displayed in the interface 930. After character selection option setting is performed in the character selection option 910, the interactive video includes at least two character roles for the player to choose to play. The matching control 931 indicates that the player is randomly matched with one role in the at least two character roles for interacting with other players. The room creation control 932 indicates that the player creates a room, and invites other players, or is matched with other players for interaction.

In some embodiments, an interaction spectator option is further included in the component editing option, that is, an interaction spectator option is further included in the component editing region. A process of setting the character selection component includes at least one of the following cases:

First, if the interaction process of the interactive video can be watched, a spectator component and a participant component are set after the background video clip in response to a selection operation on the interaction spectator option; and the character selection component associated with the participant component is set in response to the selection operation on the character selection option.

Second, if the interaction process of the interactive video cannot be watched, a character selection component is set after the background video clip in response to a selection operation on the character selection option.

In step 804, a first interactive clip is set in the video editing preview region.

In an example, in response to setting of at least two character selection options being completed, the first interactive clip is set respectively for the at least two character selection options and a story scene of the interactive video.

In step 805, an information viewing component is set at a target scene position in the first interactive clip in response to a selection operation on an information viewing option.

In step 806, a plot selection component is set in the video editing preview region in response to a selection operation on a plot selection option.

Each candidate plot option in at least two candidate plot options corresponds to one plot selection component. Alternatively, a plot selection component is set. At least two candidate plot options are set in the plot selection component.

The plot selection component is set in any video clip in the interactive video. Alternatively, the plot selection component is set in the plot selection interface in the interactive video.

When the interactive video is a video in which a plurality of players participate in interaction, in at least two candidate plot options, a candidate plot option that meets a selected condition is a finally selected candidate plot option. In an example, an unlocking condition of the plot is set to: when a quantity of unlocking players reaches n, a corresponding plot video clip is played, n being a positive integer.

Referring to FIG. 10, an interactive video 1010 and a plot selection control 1020 in a video editing preview region are displayed in a creation interface 1000 for an interactive video. In an editing region 1030 of the plot selection control 1020, an unlocking condition is displayed: when a quantity of players reaches 3, the plot is unlocked.

In step 807, plot video clips associated with candidate plot options are respectively set for at least two candidate plot options.

In an example, each candidate plot option corresponds to one plot video clip. Alternatively, in at least two candidate plot options, there are two or more candidate plot options corresponding to a same plot video clip.

A plot video clip associated with a candidate plot option represents playing a plot video clip associated with a candidate plot option when a selection signal for the candidate plot option is received.

In some embodiments, a global component is further set in the interactive video. The global component includes at least one of a message component and a voice component. A global component is a component that is created globally for the interactive video global and that can be displayed in any time period in the interactive video.

The global component is set in a manner of corresponding to an interactive video timestamp. Alternatively, the global component is set in correspondence with the video clip.

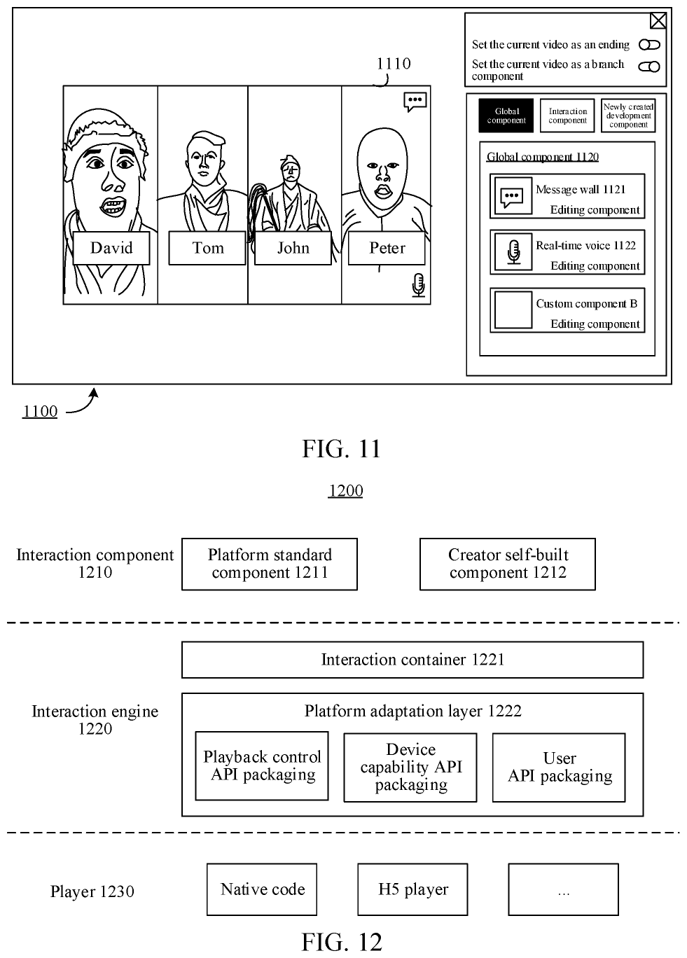

Referring to FIG. 11, an interactive video 1110 and a global control setting region 1120 in a video editing preview region are displayed in a creation interface 1100 for an interactive video. The global control setting region 1120 includes a message option 1121 and a voice option 1122. When a selection operation on the message option 1121 is received, a message component is set for the interactive video 1110 in the video editing preview region, and a display parameter is set for the message component. When a selection operation on the voice option 1122 is received, a voice component is set for the interactive video 1110 in the video editing preview region, and a display parameter is set for the voice component.

In step 808, the interactive video is generated according to the first interactive clip and other video clips.

In an example, the interactive video is generated according to the first interactive clip, the background video clip, the second interactive video clip and other video clips, as well as the components that are set.

For both the global component and the interaction component, a creator can set custom components, and set corresponding function parameters for the custom components to implement different functions.

In conclusion, in the method for creating an interactive video provided in this embodiment of this disclosure, in a process of creating an interactive video, a first interactive clip is set in the interactive video, an information viewing component is set in the first interactive clip, scene information corresponding to a scene in which the first interactive clip is located is set in the information viewing component, so as to increase an amount of information and interaction forms of the interactive clip in the interactive video. A user can view information included in the first interactive clip by selecting the information viewing component in the first interactive clip, thereby improving the efficiency of human computer interaction in an interaction process of the interactive video.

In the method provided in this embodiment, a character selection component is set in the interactive video by setting a character selection option, to provide a plurality of players with a condition for participating in interaction in the interactive video, thereby increasing the interactive forms of the interactive video, and improving the interaction efficiency of the interactive video. In addition, a plot selection component is set, to control a plot direction of the interactive video. In a case that a plurality of players participate in interaction together, the plurality of players jointly decide the plot direction through voting, which improves the interaction efficiency and increases the interaction forms.

In some embodiments, an interactive video playback system is mainly used for implementing functions, such as playback, buffering, rendering, and interaction, of the interactive video, and also acquiring user interaction data. An interactive video playback system 1200 may include a three-layer structure including a player 1230, an interaction engine 1220, and an interaction component 1210.

As shown in FIG. 12, the interaction component 1210 may provide a platform standard component 1211 and a creator self-built component 1212. For example, a multi-person teaming component, a VR panorama searching function, a multi-person voting component, a player information communication component, and the like are supported. Relevant capabilities are called from a lower-layer interaction container 1221 and the player 1230.

The interaction engine 1220 includes an interaction container 1221 and a platform adaptation layer 1222. The layered structure can better decouple the interaction control logic, the playback logic and the rendering logic, and can achieve the objective of flexibly supporting real-time interaction between content and the user real-time interaction. The platform adaptation layer 1222 includes playback control application programming interface (API) packing, device capability API packing, and user API packing.

The player 1230 includes native code of an application, an H5 player, and the like.

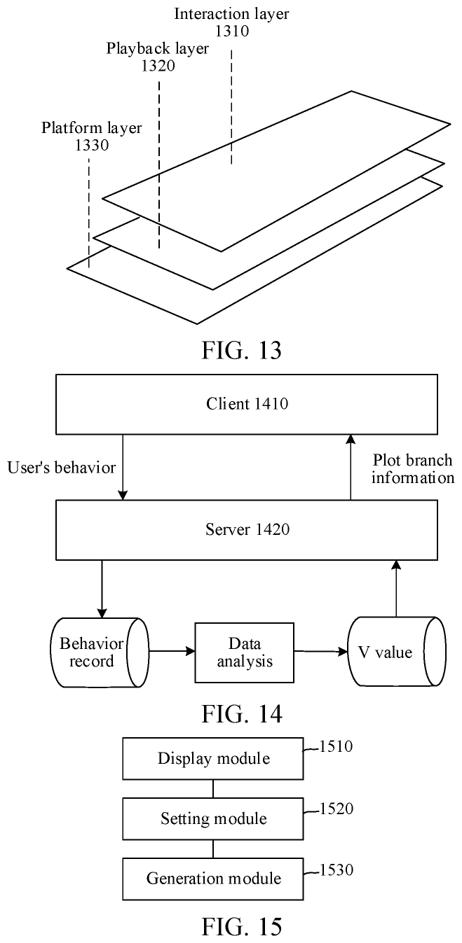

Referring to FIG. 13, on the whole, the interactive video playback system includes an interaction layer 1310, a playback layer 1320, and a platform layer 1330. The interaction layer 1310 is separated from the playback layer 1320, and the interaction layer 1310 is independent, which reduces the scale and complexity of the playback layer 1320 and improves the smoothness of the transition between a plurality of videos.

The interaction layer 1310 is above the playback layer 1320 and does not block playback of the video. The video playback transition and decoupling of the interaction layer 1310 can be implemented at the bottom, to achieving the inter-video interactive gameplay design.

In some embodiments, as shown in FIG. 14, which shows a schematic diagram of a process of driving a data flow in creation and interaction processes of an interactive video according to an exemplary embodiment of this disclosure, the process is may be divided into two aspects of data synchronization: 1. Configuration of a value set of a same component and a same variable in an editor; and 2. Synchronization and determination of a plurality of data flows.

This process involves an application (or client) 1410 and a server 1420.

The application 1410 reports a behavior of the user to the server 1420, and an operation behavior of the user in a specific interaction node is referred to as a behavior event, for example, a click, a slide, a browsing time length, a click speed, a user facial expression, a shake, or a blow. The operation behavior may be a behavior acquired by an interactive terminal sensor, or a combination of a plurality of behaviors.

The server 1420 stores the behavior event. To process the complex and various behaviors in a unified format, the reported behavior event is abstracted into a behavior ID and a behavior value and stored in a log database of the server 1420. The abstracted data is basic data for subsequent formula calculation and feature extraction. A statistical calculation model generates a new V value by performing feature vector extraction on behavior records. The server 1420 returns corresponding plot branch information to the application 1410 according to the multi-dimensional V value decision.

FIG. 15 is a structural block diagram of an apparatus for creating an interactive video according to an exemplary embodiment of this disclosure. The apparatus may be implemented as an entire computer device or a part of the computer device by using software, hardware, or a combination thereof. The apparatus may include a display module 1510, a setting module 1520, and a generation module 1530. One or more modules, submodules, and/or units of the apparatus can be implemented by processing circuitry, software, or a combination thereof, for example.

The display module 1510 is configured to display a creation interface for an interactive video, the creation interface including a video editing preview region and a component editing region, the component editing region including an information viewing option. The setting module 1520 is configured to set a first interactive clip in the video editing preview region, the first interactive clip being used for providing an information acquisition scene. The setting module 1520 is further configured to set an information viewing component at a target scene position in the first interactive clip in response to a selection operation on the information viewing option, the information viewing component being used for presenting acquirable information in the information acquisition scene. The generation module 1530 is configured to generate the interactive video according to the information viewing component set in the first interactive clip.

In an embodiment, the first interactive clip is a virtual reality clip, the information acquisition scene is a three-dimensional virtual scene presented in the virtual reality clip, and the target scene position is a three-dimensional position in the three-dimensional virtual scene.

In an embodiment, the setting module 1520 is further configured to set the information viewing component at a preset position in a target display scene in the first interactive clip, the target display scene being at least one display scene included in the information acquisition scene.

The apparatus further may include a receiving module 1540. The receiving model 1540 is configured to receive a drag operation on the information viewing component, the drag operation being used for moving a set position of the information viewing component in the target display scene; and determine the target scene position of the information viewing component in the target display scene according to the drag operation.

The setting module 1520 is further configured to set the information viewing component at the target scene position.

In an embodiment, the component editing region further includes a component editing control corresponding to the information viewing component.

The display module 1510 is further configured to display an information editing region in response to a trigger operation on the component editing control, the information editing region including an information title editing region and an information content editing region.

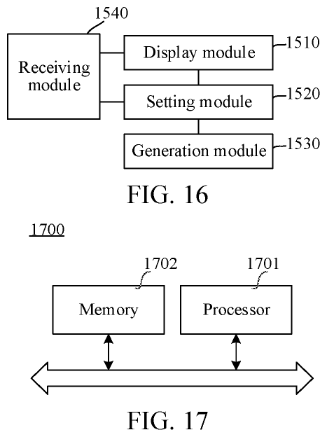

As shown in FIG. 16, the receiving module 1540 is further configured to receive a title input operation in the information title editing region, and generate a title corresponding to the information viewing component; and receive a content input operation in the information content editing region, and generate information content corresponding to the information viewing component.

In an embodiment, the component editing region further includes a result selection option.

The setting module 1520 is further configured to set a second interactive video clip in the video editing preview region.

The setting module 1520 is further configured to set a result selection component in correspondence to the second interactive video clip in response to a selection operation on the result selection option, the result selection component being used for selecting an ending of the interactive video.

In an embodiment, the result selection component includes at least two candidates.

The apparatus may further include a receiving module 1540, configured to receive a result video setting operation on a target candidate in the at least two candidates.

The setting module 1520 is further configured to set a target result video as a result video associated with the target candidate according to the result video setting operation.

In an embodiment, the component editing region further includes a character selection option.

The setting module 1520 is further configured to set a background video clip in the video editing preview region, the background video clip being used for providing a story background of the interactive video.

The setting module 1520 is further configured to set a character selection component after the background video clip in response to a selection operation on the character selection option, the character selection component being used for selecting a role played in the interactive video.

In an embodiment, the component editing region further includes an interaction spectator option.

The setting module 1520 is further configured to set a spectator component and a participant component after the background video clip in response to a selection operation on the interaction spectator option; and set the character selection component associated with the participant component in response to the selection operation on the character selection option.

In an embodiment, the setting module 1520 is further configured to set, in response to that setting of at least two character selection options is completed, the first interactive clip respectively for the at least two character selection options and a story scene of the interactive video.

In an embodiment, the component editing region further includes a plot selection option.

The setting module 1520 is further configured to set a plot selection component in the video editing preview region in response to a selection operation on the plot selection option, the plot selection component including at least two candidate plot options; and set plot video clips associated with the candidate plot options respectively for the at least two candidate plot options.

In conclusion, in the apparatus for creating an interactive video provided in this embodiment of this disclosure, in a process of creating an interactive video, a first interactive clip is set in the interactive video, an information viewing component is set in the first interactive clip, scene information corresponding to a scene in which the first interactive clip is located is set in the information viewing component, so as to increase an amount of information and interaction forms of the interactive clip in the interactive video. A user can view information included in the first interactive clip by selecting the information viewing component in the first interactive clip, thereby improving the efficiency of human computer interaction in an interaction process of the interactive video.

The apparatus for creating an interactive video provided in the foregoing embodiments is illustrated with an example of division of the foregoing functional modules. In actual application, the functions may be allocated to and completed by different functional modules according to requirements, that is, the internal structure of the device is divided into different functional modules, to implement all or some of the functions described above. In addition, the apparatus for creating an interactive video provided in the foregoing embodiment and the embodiments of the method for creating an interactive video belong to similar concepts. For an exemplary implementation process, reference may be made to the method embodiments, and details are not described herein again. In addition, the term “a plurality of” in the embodiments means two or more, that is, “at least two”.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 17 is a structural block diagram of a terminal 1700 according to an exemplary embodiment of this disclosure.

Generally, the terminal 1700 includes a processor 1701 and a memory 1702.

Processing circuitry, such as the processor 1701, may include one or more processing cores, and may be, for example, a 4-core processor or an 8-core processor. The processor 1701 may be implemented in at least one hardware form of a digital signal processor (DSP), a field-programmable gate array (FPGA), or a programmable logic array (PLA). The processor 1701 may also include a main processor and a coprocessor. The main processor is configured to process data in an active state, also referred to as a central processing unit (CPU). The coprocessor is a low-power processor configured to process data in a standby state. In some embodiments, the processor 1701 may be integrated with a graphics processing unit (GPU). The GPU is configured to be responsible for rendering and drawing content that a display screen needs to display.

The memory 1702 may include one or more computer-readable storage media that may be non-transitory. The memory 1702 may further include a high-speed random-access memory and a non-volatile memory, for example, one or more disk storage devices or flash storage devices. In some embodiments, the non-transitory computer-readable storage medium in the memory 1702 is configured to store at least one instruction, and the at least one instruction being configured to be executed by the processor 1701 to implement the method for creating an interactive video provided in the method embodiments of this disclosure.

In some embodiments, the terminal 1700 may further include a radio frequency circuitry, a display screen, an audio circuit, and a power supply.

The radio frequency circuit is configured to receive and transmit a radio frequency (RF) signal that is also referred to as an electromagnetic signal. The RF circuit communicates with a communication network and other communication devices through the electromagnetic signal. The RF circuit converts an electrical signal into an electromagnetic signal for transmission, or converts a received electromagnetic signal into an electrical signal. In an example, the RF circuit includes: an antenna system, an RF transceiver, one or more amplifiers, a tuner, an oscillator, a digital signal processor, a codec chipset, a user identity module card, and the like. The RF circuit may communicate with other terminals by using at least one wireless communication protocol. The wireless communication protocol includes, but is not limited to, a world wide web, a metropolitan area network, an intranet, generations of mobile communication networks (2G, 3G, 4G, and 5G), a wireless local area network, and/or Wi-Fi network.

The display screen is configured to display a user interface (UI). The UI may include graphics, text, icons, videos, and any combination thereof.

The audio circuit may include a speaker. The speaker is configured to convert electrical signals from the processor 1701 or the RF circuit into sound waves. The speaker may be a conventional thin-film speaker or a piezoelectric ceramic speaker. In some embodiments, the audio circuit may further include a headphone jack.

The power supply is configured to supply power to components in the terminal 1700. The power supply may be an alternating-current power supply, a direct-current power supply, a disposable battery, or a rechargeable battery. When the power supply includes the rechargeable battery, the rechargeable battery may be a wired charging battery or a wireless charging battery. The wired charging battery is a battery charged through a wired line, and the wireless charging battery is a battery charged through a wireless coil. The rechargeable battery may further be configured to support a quick charge technology.

A person skilled in the art may understand that the structure shown in FIG. 17 constitutes no limitation on the terminal 1700, and the terminal may include more or fewer components than those shown in the figure, or some components may be combined, or a different component deployment may be used.

An embodiment of this disclosure further provides a computer device, including a memory and a processor, the memory storing at least one instruction, at least one program, a code set, or an instruction set, and the at least one instruction, the at least one program, the code set, or the instruction set being loaded by the processor to implement the method for creating an interactive video according to the foregoing embodiments of this disclosure.

This disclosure further provides a computer program, including computer instructions, the computer instructions being stored in a computer-readable storage medium. A processor of a computer device reads the computer instructions from the computer-readable storage medium and executes the computer instructions to cause the computer device to perform the method for creating an interactive video according to any one of the foregoing embodiments.

This disclosure further provides a computer program product, including computer instructions, the computer instructions being stored in a computer-readable storage medium. A processor of a computer device reads the computer instructions from the computer-readable storage medium and executes the computer instructions to cause the computer device to perform the method for creating an interactive video according to any one of the foregoing embodiments.

A person of ordinary skill in the art may understand that all or some of the steps of the methods in the embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and that is not assembled in a terminal. The computer-readable storage medium stores at least one instruction, at least one program, a code set or an instruction set, the at least one instruction, the at least one program, the code set or the instruction set being loaded and executed by the processor to implement the method for creating an interactive video according to any one of the embodiments of this disclosure.

In an example, the computer-readable storage medium may include: a read-only memory (ROM), a random-access memory (RAM), a solid state drive (SSD), an optical disc, or the like. The RAM may include a resistive RAM (ReRAM) and a dynamic RAM (DRAM). The sequence numbers of the foregoing embodiments of this disclosure are merely for description purposes, and do not indicate the preference among the embodiments.

A person of ordinary skill in the art may understand that all or some of the steps of the foregoing embodiments may be implemented by hardware, or may be implemented by a program instructing related hardware. The program may be stored in a computer-readable storage medium. The storage medium may be: a ROM, a magnetic disk, or an optical disc.

The foregoing descriptions are merely exemplary embodiments of this disclosure, but are not intended to limit this disclosure. Other embodiments shall fall within the scope of this disclosure.

What is claimed is:

1. A method for creating an interactive video, the method comprising:
displaying an interactive video creation interface, the interactive video creation interface including a video editing preview region and a component editing region;
adding a first interactive clip to the video editing preview region, the first interactive clip including a display scene;
adding an information viewing component to a target position in the display scene of the first interactive clip based on selection of an information viewing option that is included in the component editing region, the information viewing component being configured to present information in the display scene when selected by a user of the interactive video; and
generating, by processing circuitry, the interactive video according to the information viewing component added to the first interactive clip.

2. The method according to claim 1, wherein the first interactive clip is a virtual reality clip, the display scene is a three-dimensional virtual scene in the virtual reality clip, and the target position in the display scene is a three-dimensional position in the three-dimensional virtual scene.

3. The method according to claim 2, wherein the adding the information viewing component comprises:
adding the information viewing component to a preset position in the display scene of the first interactive clip;
receiving a drag operation on the information viewing component added to the preset position in the display scene of the first interactive clip to move the information viewing component to the target position in the display scene; and
determining the target position of the information viewing component in the display scene of the first interactive clip according to the drag operation.

4. The method according to claim 3, wherein
the component editing region further includes a component editing control interface corresponding to the information viewing component; and
after the adding the information viewing component, the method further comprises:
displaying an information editing region based on a trigger operation on the component editing control interface, the information editing region including an information title editing region and an information content editing region,
receiving a title input in the information title editing region,
generating a title corresponding to the information viewing component based on the input title,
receiving a content input in the information content editing region, and
generating information content corresponding to the information viewing component based on the input content.

5. The method according to claim 1, wherein
the component editing region further includes a result selection option; and
the method further comprises:
adding a second interactive video clip to the video editing preview region; and
adding a result selection component in correspondence to the second interactive video clip based on selection of the result selection option in the component editing region, the result selection component being configured to provide a user interface for the user of the interactive video to select an ending of the interactive video.

6. The method according to claim 5, wherein
the result selection component includes at least two candidates; and
the method further comprises:
receiving a result video setting operation on a target candidate in the at least two candidates; and
setting a target result video in association with the target candidate according to the result video setting operation.

7. The method according to claim 1, wherein
the component editing region further includes a character selection option; and
the method further comprises:
adding a background video clip to the video editing preview region, the background video clip including a story background of the interactive video; and
adding a character selection component after the background video clip based on selection of the character selection option in the component editing region, the character selection component being configured to provide a user interface for the user of the interactive video to select a role to be played in the interactive video.

8. The method according to claim 7, wherein
the component editing region further includes an interaction spectator option; and
the adding the character selection component comprises:
adding a spectator component and a participant component after the background video clip based on selection of the interaction spectator option in the component editing region, and
setting the character selection component in association with the participant component based on the selection of the character selection option in the component editing region.

9. The method according to claim 1, wherein the adding the first interactive clip comprises:
setting the first interactive clip in association with a first character selection option and a second interactive clip in association with a second character selection option.

10. The method according to claim 1, wherein
the component editing region further includes a plot selection option; and
the method further comprises:
adding a plot selection component to the video editing preview region in response to selection of the plot selection option in the component editing region, the plot selection component including at least two candidate plot options and being configured to present the at least two candidate plot options for selection by the user of the interactive video, and
setting different plot video clips in association with the at least two candidate plot options.

11. An apparatus, comprising:
processing circuitry configured to:
display an interactive video creation interface, the interactive video creation interface including a video editing preview region and a component editing region;
add a first interactive clip to the video editing preview region, the first interactive clip including a display scene;
add an information viewing component to a target position in the display scene of the first interactive clip based on selection of an information viewing option that is included in the component editing region, the information viewing component being configured to present information in the display scene when selected by a user of an interactive video; and
generate the interactive video according to the information viewing component added to the first interactive clip.

12. The apparatus according to claim 11, wherein the first interactive clip is a virtual reality clip, the display scene is a three-dimensional virtual scene in the virtual reality clip, and the target position in the display scene is a three-dimensional position in the three-dimensional virtual scene.

13. The apparatus according to claim 12, wherein the processing circuitry is configured to:
add the information viewing component to a preset position in the display scene of the first interactive clip;
receive a drag operation on the information viewing component added to the preset position in the display scene of the first interactive clip to move the information viewing component to the target position in the display scene; and
determine the target position of the information viewing component in the display scene of the first interactive clip according to the drag operation.

14. The apparatus according to claim 13, wherein
the component editing region further includes a component editing control interface corresponding to the information viewing component; and
after the adding the information viewing component, the processing circuitry is configured to:
display an information editing region based on a trigger operation on the component editing control interface, the information editing region including an information title editing region and an information content editing region,
receive a title input in the information title editing region,
generate a title corresponding to the information viewing component based on the input title,
receive a content input in the information content editing region, and
generate information content corresponding to the information viewing component based on the input content.

15. The apparatus according to claim 11, wherein
the component editing region further includes a result selection option; and
the processing circuitry is configured to:
add a second interactive video clip to the video editing preview region; and
add a result selection component in correspondence to the second interactive video clip based on selection of the result selection option in the component editing region, the result selection component being configured to provide a user interface for the user of the interactive video to select an ending of the interactive video.

16. The apparatus according to claim 15, wherein
the result selection component includes at least two candidates; and
the processing circuitry configured to:
receive a result video setting operation on a target candidate in the at least two candidates; and
set a target result video in association with the target candidate according to the result video setting operation.

17. The apparatus according to claim 11, wherein
the component editing region further includes a character selection option; and
the processing circuitry is configured to:
add a background video clip to the video editing preview region, the background video clip including a story background of the interactive video; and
add a character selection component after the background video clip based on selection of the character selection option in the component editing region, the character selection component being configured to provide a user interface for the user of the interactive video to select a role to be played in the interactive video.

18. The apparatus according to claim 17, wherein
the component editing region further includes an interaction spectator option; and
the processing circuitry is configured to:
add a spectator component and a participant component after the background video clip based on selection of the interaction spectator option in the component editing region, and
set the character selection component in association with the participant component based on the selection of the character selection option in the component editing region.

19. The apparatus according to claim 11, wherein the processing circuitry is configured to:
set the first interactive clip in association with a first character selection option and a second interactive clip in association with a second character selection option.

20. A non-transitory computer-readable storage medium, storing instructions which when executed by a processor cause the processor to perform:
displaying an interactive video creation interface, the interactive video creation interface including a video editing preview region and a component editing region;
adding a first interactive clip to the video editing preview region, the first interactive clip including a display scene;
adding an information viewing component to a target position in the display scene of the first interactive clip based on selection of an information viewing option that is included in the component editing region, the information viewing component being configured to present information in the display scene when selected by a user of an interactive video; and
generating the interactive video according to the information viewing component added to the first interactive clip.
